(19) United States
(12) Patent Application Publication
(10) Pub. No.: US 2024/0115063 A1
(43) Pub. Date: Apr. 11, 2024

(54) Method for at least partially closing a main opening of a drinking straw

(71) Applicant: Henkel AG & Co. KGaA, Dusseldorf (DE)

(72) Inventor: Christian Lipp, Monchengladbach (DE)

(21) Appl. No.: 18/391,949

(22) Filed: Dec. 21, 2023

Related U.S. Application Data
(63) Continuation of application No. PCT/EP22/64613, filed on May 30, 2022.

(30) Foreign Application Priority Data
Jul. 7, 2021 (EP) 21184179.6

(51) Int. Cl. A47G 21/18

(52) U.S. Cl. CPC A47G 21/185

(57) ABSTRACT

The invention relates to a method for closing the ends of a drinking straw (1) on the basis of paper, comprising the following steps: providing a tubular drinking straw (1) on the basis of paper; cutting to size an end region of the drinking straw (1) so that a tongue-shaped portion (4) is formed; reversing the tongue-shaped portion (4) over the opening (3a) of the drinking straw (1) so that two lateral openings (10) are formed; adhesively bonding the tongue-shaped portion (4) with the outer side of the wall (2) of the drinking straw (1).

Straws for sucking and drinking liquids have long been known in various designs. In a basic embodiment, this is an elongated tube open at both ends, wherein one end is immersed in the liquid to be ingested and the other end is placed in the mouth by a consumer.

More recently, there have also been variants in which the opening at the end of the drinking straw to be taken into the mouth by the consumer is closed and instead several, for example four, small holes are provided at the upper end of the drinking straw in the area of the wall, through which the liquid can be sucked in and enter the consumer's mouth. These straws are also known as “sensory straws”. The drink escaping from several small openings results in a different and often more pleasant drinking sensation, as the liquid does not escape from the main opening in a single current, but is simultaneously linked to different areas of the mouth through the small holes. For the purposes of the invention, a closure at the end of a drinking straw is understood to mean an at least partial closure of a main opening of a drinking straw.

The end of the main opening of drinking straws made of thermoplastics such as polyethylene or polypropylene is closed by welding using heat and pressure. Subsequently, the outlet openings are drilled or punched as small holes in the wall of the drinking straw.

In recent years, increasing environmental and sustainability awareness worldwide has led to political and economic requirements to reduce plastic packaging in the future and, in particular, to avoid single-use plastic items altogether wherever possible. In this context, drinking straws are also increasingly being produced from other, preferably biodegradable materials. For example, drinking straws made from paper or sugar cane already exist.

To make a paper-based drinking straw into a “sensory straw”, different techniques must be used to close the opening at the end compared to plastic straws. Instead of welding, the end area of the drinking straw can be glued. To do this, apply a small amount of adhesive to one end area of the drinking straw and position it precisely. Subsequently, this area is pressed together in such a manner that the wall areas of the drinking straw stick together and the opening is closed. Similar to a plastic drinking straw, small holes must be drilled or punched into the wall as outlet openings. The problem with this procedure is the precise positioning of a defined small amount of adhesive inside the hollow body. This is a complex process and therefore comparatively time-consuming and cost-intensive.

The object of the present invention is therefore to provide a method for closing the end of a drinking straw based on paper, which can be performed more simply in terms of process technology and thus more quickly and cost-effectively than known methods.

This object is achieved by a method having the features of claim 1.

Advantageous embodiments and further embodiments of the invention are the subject matter of the dependent claims.

In accordance with claim 1, the invention is a method for sealing the end of a paper-based drinking straw, comprising the following steps:
providing a tubular drinking straw based on paper;
cutting an end area of the drinking straw so that a tongue-shaped portion is designed;
folding the tongue-shaped portion over the opening of the drinking straw so that two lateral openings are designed;
bonding the tongue-shaped portion to the exterior side of the wall of the drinking straw.

In other words, the method according to the invention provides that a tab-like, tongue-shaped portion is designed in an end area of the drinking straw by appropriate cutting, which is folded over the opening of the drinking straw and bonded to the exterior side of the wall of the drinking straw. The adhesive required for bonding can be applied either to the exterior side of the wall of the drinking straw or in the area of the tongue-shaped portion. In both cases, it is not necessary to insert the adhesive into the tubular hollow body. Such bonding on the exterior side of the wall of the drinking straw is significantly easier to realize in terms of process technology and can be achieved more efficiently and thus more cost-effectively.

The invention provides for the tongue-shaped portion to be folded over and bonded to the exterior side of the wall of the drinking straw in such a manner that two lateral openings are designed. In other words, the tongue-shaped portion is folded over only enough to leave two openings on the sides opposite one another. In this position, the tongue-shaped portion is glued to the exterior side of the wall of the drinking straw. When using the drinking straw, liquid can be sucked in through the openings on the side and get into the consumer's mouth. The size of these openings can be adjusted within certain limits via the size of the overlap between the tongue-shaped portion and the wall of the drinking straw.

Folding the tongue-shaped portion over the opening of the drinking straw can preferably be supported by using a mandrel. This is a round bar with a diameter adapted to the desired size of the side openings. By folding the tongue-shaped portion around the mandrel in the circumferential direction, it is particularly easy to impose a uniform curvature on the tongue-shaped portion and neatly shape the curve in the end area of the drinking straw. The size of the lateral openings can be influenced by the choice of mandrels of different diameters.

The method according to the invention is thus not only characterized by the fact that it is simplified by the adhesive application on the exterior side, it also has the advantage that two small lateral openings are already designed directly when the drinking straw is folded over and glued on the end side and do not have to be introduced separately in a subsequent method step.

Nevertheless, in accordance with the invention, it may be provided that, in addition to the two lateral openings, further small holes are made in the wall of the drinking straw, for example by drilling or punching. Preferably, two further diametrically opposed holes can be made in a single drilling or punching operation by driving a corresponding tool completely through the tubular drinking straw once in a direction perpendicular to its longitudinal axis. A particularly pleasant drinking sensation is achieved if the openings on the sides and the additional holes are substantially evenly distributed around the circumference of the drinking straw.

In accordance with one embodiment of the method according to the invention, a fast-setting hot-melt adhesive suitable for food contact is used to bond the tongue-shaped portion to the exterior side of the wall of the drinking straw. This can be, for example, the polyolefin hot-melt adhesive from Henkel known as Technomelt Supra PRO 220 Plus. Other suitable hot-melt adhesives can also be used. A fast-setting hot-melt adhesive has the advantage that the bonding of the tongue-shaped portion and the wall of the drinking straw holds reliably after just a short period of pressure. In addition, such adhesives are generally low-migration and therefore particularly suitable for food contact. The adhesive can be applied in a manner known per se, for example by means of a nozzle or a pane.

In accordance with one embodiment of the method according to the invention, the end area of the drinking straw is cut to size by making two first cuts along two first cutting lines starting from an end edge of the drinking straw into the wall of the drinking straw and making a second cut along a second cutting line, wherein the second cut is made in a direction parallel to the end edge of the drinking straw and the cutting line connects the end points of the two first cutting lines to one another.

Preferably, the two first cuts are designed simultaneously in a single cutting process using a cutting tool that is positioned at a point on the end edge and inserted into the wall of the drinking straw at an angle with respect to the longitudinal direction of the drinking straw.

The end area of the drinking straw can thus be cut to size, for example, by first making two first cuts along two first cutting lines over a length of approximately 1 to 3 cm in a single cutting process, starting from an end edge of the drinking straw, into the wall using a knife set at an angle at a point on the end edge. A second cut connecting the two first cut lines at their end points in a direction parallel to the end edge separates a partial area from the wall of the drinking straw, simultaneously designing a tongue-shaped portion which protrudes beyond the opening of the drinking straw.

The contour of the tongue-shaped portion can always be cut to the desired shape. However, the described exact positioning of a cutting tool at a point on the end edge of the drinking straw and the insertion of the cutting tool into the wall at an angle to the longitudinal direction of the drinking straw automatically results in a tongue-shaped portion which tapers towards its free end and is designed to be rounded at its free end.

A particularly favorable contour of the tongue-shaped portion is achieved if the two portions initially made are at an angle of approximately 5° to 35°, preferably approximately 10° to 20°, with respect to the longitudinal direction of the drinking straw. For example, the cuts can be made in the wall at an angle of approximately 15° to the longitudinal direction of the drinking straw. The cutting tool can be positioned at a point on the end edge and inserted into the wall of the drinking straw at the desired angle in relation to the longitudinal direction of the straw over a length of approximately 1 to 3 cm, so that two cuts are designed simultaneously.

The second cut, which connects the two first cut lines at their end points, is made in a direction parallel to the edge of the drinking straw and perpendicular to its longitudinal direction. The cutting depth of this second cut into the drinking straw is preferably approximately half to ⅔ of the diameter of the drinking straw. A particularly favorable contour of the tongue-shaped portion is achieved if the second cut has a cutting depth of approximately ⅗ of the diameter of the drinking straw.

The first two cuts and the second cut can be made either simultaneously or one after the other. In particular, a first cutting tool can be used to make the first cuts and a second cutting tool can be used to make the second cut.

In principle, the size of the resulting lateral openings can be influenced by the specific design of the outer contour of the tongue-shaped portion and the extent to which the folded tongue-shaped portion overlaps with the wall of the drinking straw.

In accordance with one embodiment of the method according to the invention, it is provided that the tongue-shaped portion is designed to be rounded at its free end. This ensures that the free end can be securely bonded to the exterior side of the wall without any corners protruding.

The invention provides a method for the production of end-sealed drinking straws based on paper, by means of which such drinking straws can be produced very efficiently in large quantities.

In the following, the invention is explained in more detail by means of an exemplary embodiment and with reference to the attached figures. In the figures:

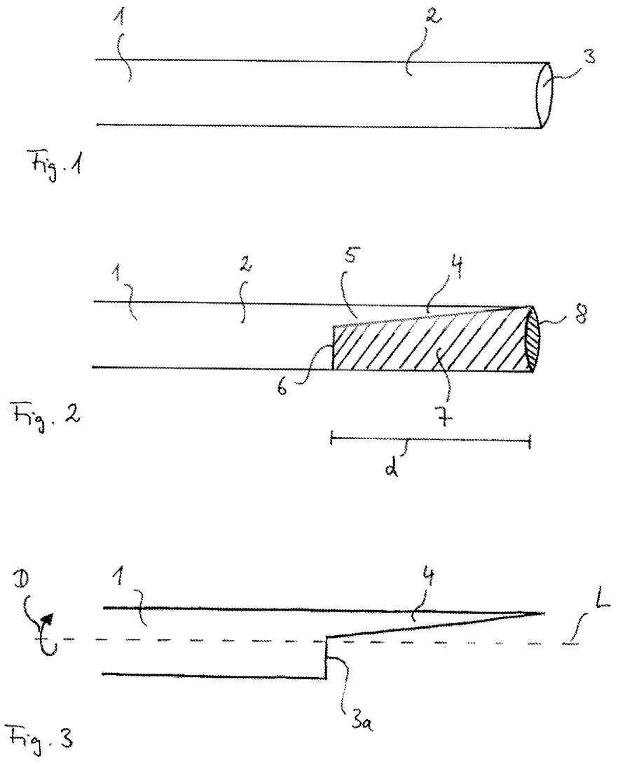

FIG. 1 shows a portion of a paper-based drinking straw in a lateral, slightly oblique view;

FIG. 2 shows the drinking straw from FIG. 1, wherein an area to be cut to size is marked;

FIG. 3 shows a side view of the drinking straw from FIG. 1 after it has been cut to size;

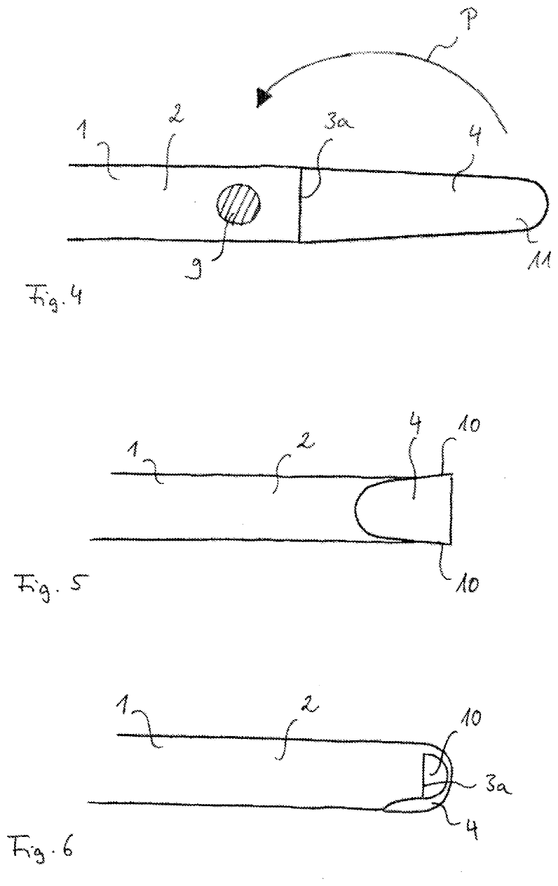

FIG. 4 shows the cut drinking straw from FIG. 3 in a view rotated by 90° around the longitudinal axis;

FIG. 5 shows the drinking straw from FIG. 4, wherein the tongue-shaped portion has been folded over the opening of the drinking straw and glued to the exterior side of the wall of the drinking straw;

FIG. 6 shows the drinking straw from FIG. 5 in a view rotated by 90° around the longitudinal axis.

FIGS. 1 to 6 show a portion of a paper-based drinking straw 1 as it passes through the individual method steps of the method according to the invention. The representations are merely schematic and not necessarily to scale.

FIG. 1 shows the end area of the drinking straw 1 as it is provided for the method in a first step. The drinking straw 1 is designed as a tubular hollow body with a wall 2 and openings at the ends, wherein only one opening 3 at the end is shown in the representation of FIG. 1. The drinking straw 1 is made of paper.

In a subsequent method step, the end area of the drinking straw 1 is cut to size so that a tongue-shaped portion 4 is designed. In FIG. 2, the area 7 to be removed by cutting is shown hatched. In detail, the cutting is initially carried out along two first cutting lines 5, of which only the cutting line 5 facing the viewer can be seen in FIG. 2. The cut lines 5 start at the end edge 8 of the drinking straw 1 and extend from there through the wall 2 of the drinking straw 1 at a slight angle of approximately 15° to the longitudinal direction L of the drinking straw. The two first cuts along the first cutting lines 5 are made simultaneously in a single cutting process by a cutting tool attached to the end edge 8 of the drinking straw 1. At a distance d of approximately 1.5 cm from the end edge 8, the first cutting lines 5 end or merge into a second cutting line 6, which extends substantially parallel to the end edge 8 and which connects the ends of the two first cutting lines 5 with one another. The cutting depth of the second cut along the second cutting line 6 is approximately ⅗ of the diameter of the drinking straw. By cutting along the cutting lines 5 and 6, the hatched area 7 shown in FIG. 2 can thus be removed from the wall 2 of the drinking straw 1. Adjacent to the second cut line 6, a new opening 3a of the drinking straw 1 is created.

FIG. 3 shows a lateral view of a drinking straw 1 cut in this manner, FIG. 4 shows the same drinking straw 1 after a 90° rotation about the longitudinal axis in a direction indicated by the rotation arrow D. Clearly visible is the protruding tongue-shaped portion 4, which is designed to be rounded at its free end 11.

In a subsequent method step, the tongue-shaped portion 4 is folded over the opening 3a in accordance with the arrow P in FIG. 4 and bonded to the exterior side of the wall 2 of the drinking straw 1. For this purpose, a quick-setting hot-melt adhesive suitable for food contact is applied to the exterior side 2 of the wall of the drinking straw 1 in the area labeled 9 in FIG. 4. By means of the hot-melt adhesive, the tongue-shaped portion 4 is bonded to the exterior side of the wall 2 of the drinking straw 1, so that the opening 3a is substantially closed, see FIG. 5. However, the overlap of the tongue-shaped portion 4 with the wall 2 of the drinking straw 1 is selected during folding and gluing in such a manner that two lateral openings 10 are designed, which can be seen in particular in the representation of FIG. 6. FIG. 6 shows the drinking straw 1 again in the same orientation as in FIG. 3, i.e. rotated back by 90° about the longitudinal axis compared to the representations in FIGS. 4 and 5.

The size of the openings 10 can be scaled by the dimension of the overlap between the tongue-shaped portion 4 and the wall 2 of the drinking straw 1, i.e. the openings 10 become smaller the further the tongue-shaped portion 4 is placed over the wall 2.

For a pleasant drinking sensation, it may already be sufficient for the liquid drawn in by the drinking straw 1 to emerge from the two opposing openings 10 and thus be linked to different areas of a consumer's mouth. In an alternative embodiment of the method according to the invention, however, it may also be provided to make further small holes, not shown in the figures, in the wall 2 of the drinking straw 1 as outlet openings in addition to the two lateral openings 10. These can be drilled or punched into the wall 2, for example. By driving a corresponding tool once completely through the drinking straw 1 in a direction perpendicular to its longitudinal axis, two further diametrically opposed holes can be made in the wall 2 in a single drilling or punching operation. These additional holes penetrate the wall 2 of the drinking straw 1 and, depending on the arrangement, also the area of the tongue-shaped portion 4 overlapping with the wall 2.

1: A method of sealing the end of a paper-based drinking straw (1) comprising the following steps:
providing a tubular drinking straw (1) based on paper;
cutting an end area of the drinking straw (1) so that a tongue-shaped portion (4) is designed;
folding the tongue-shaped portion (4) over the opening (3a) of the drinking straw (1), so that two lateral openings (10) are designed; and
adhesively bonding the tongue-shaped portion (4) with the outer side of the wall (2) of the drinking straw (1).

2: The method according to claim 1, characterized in that, for bonding the tongue-shaped portion (4) to the exterior side of the wall (2) of the drinking straw (1), a defined amount of adhesive is applied to the exterior side of the wall (2) of the drinking straw (1).

3: The method according to claim 1, characterized in that, in addition to the two lateral openings, at least one hole is made in the wall (2) of the drinking straw (1).

4: The method according to claim 3, characterized in that, in addition to the two lateral openings, two diametrically opposite holes are made in the wall (2) of the drinking straw (1).

5: The method according to claim 1, characterized in that the end area of the drinking straw (1) is cut by making two first cuts along two first cut lines (5) starting from an end edge (8) of the drinking straw (1) into the wall (2) of the drinking straw (1) and making a second cut along a second cut line (6), wherein the second cut is made in a direction parallel to the end edge (8) of the drinking straw (1) and the cutting line (6) connects the end points of the two first cutting lines (5).

6: The method according to claim 5, characterized in that the two first cuts are designed simultaneously in a single cutting operation with the aid of a cutting tool which is positioned at a point on the end edge (8) and is inserted into the wall (2) of the drinking straw (1) at an angle with respect to the longitudinal direction (L) of the drinking straw.

7: The method according to claim 6, characterized in that the angle with respect to the longitudinal direction (L) is 10° to 20.

8: The method according to claim 5, characterized in that the cutting depth of the second cut into the drinking straw (1) is half to ⅗ of the diameter of the drinking straw (1).

9: The method according to claim 1, characterized in that the tongue-shaped portion (4) is designed to be rounded at its free end (11).

10: The method according to claim 1, characterized in that the adhesively bonding the tongue-shaped portion over the opening of the drinking straw comprises a fast-setting, food contact suitable hot-melt adhesive.
